(19) United States
(12) Patent Application Publication
(10) Pub. No.: US 2026/0361789 A1
(43) Pub. Date: Nov. 12, 2026

(54) DATA PLANE COMPRISING A GATEWAY AND SOFTWARE ACCELERATORS FOR COMMUNICATIONS BETWEEN FUNCTIONS

(71) Applicant: HEWLETT PACKARD ENTERPRISE DEVELOPMENT LP, Spring, TX (US)

(72) Inventors: Hardik Soni, Hesse (DE); Shixiong Qi, Lexington, KY (US); Diman Zad Tootaghaj, Milpitas, CA (US); Kadangode K. Ramakrishnan, Milpitas, CA (US); Puneet Sharma, Palo Alto, CA (US)

(21) Appl. No.: 19/203,726

(22) Filed: May 9, 2025

(51) Int. Cl. H04L 67/1097

(52) U.S. Cl. CPC H04L 67/1097

(57) ABSTRACT

In some examples, a system includes a first computing node and a second computing node. The first computing node includes a plurality of functions of a chain of functions, and software accelerators associated with respective functions of the plurality of functions. The software accelerators can perform intra-node data communications between the plurality of functions using a shared memory in the first computing node. The first computing node includes a gateway having descriptor queues to store descriptors for data communications, and a router to perform an inter-node Remote Direct Memory Access (RDMA) transfer of data from a first function of the plurality of functions on the first computing node to a second function of the chain of functions on the second computing node.

### BACKGROUND

Cloud computing (such as serverless cloud computing) allows a user to request resources of a cloud computing environment according to an on-demand basis to implement the user's services. The cloud computing environment may be operated by a cloud provider, and the user may be a tenant (or a member of the tenant) of the cloud provider.

### BRIEF DESCRIPTION OF THE DRAWINGS

Some implementations of the present disclosure are described with respect to the following figures.

FIG. 1 is a block diagram of an arrangement that includes worker nodes, an ingress gateway, a control plane, and clients, in accordance with some examples.

FIG. 2 is a block diagram of a worker node according to some examples of the present disclosure.

FIG. 3 is a block diagram of an arrangement that includes a worker node and an ingress gateway, according to some examples.

FIG. 4 is a block diagram of a worker node according to some examples.

FIG. 5 is a block diagram of a storage medium storing machine-readable instructions according to some examples.

FIG. 6 is a flow diagram of a process according to some examples.

FIG. 7 is a block diagram of an intra-node data plane, according to some examples.

FIG. 8 is a block diagram of an inter-node data plane, according to some examples.

FIG. 9 is a flow diagram of a transmission pipeline process according to some examples.

FIG. 10 is a flow diagram of a reception pipeline process according to some examples.

FIG. 11 is a block diagram of a system according to some examples.

FIG. 12 is a block diagram of a storage medium storing machine-readable instructions according to some examples.

FIG. 13 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Serverless cloud computing involves the use of functions, referred to as “serverless functions” or “functions as a service (FaaS),” to build a service. Each function is considered a basic execution unit of serverless computing and implements a respective part of the service. The functions can be combined into a workflow of the service, where the functions have specified dependencies in the workflow and are triggered in response to events. Serverless computing allows users (e.g., program developers or other types of users) to simply write program code to implement the functions, without having to worry about provisioning and managing resources of the cloud computing environment. Instead, the serverless infrastructure is responsible for provisioning and managing resources for the functions, including selecting resources for the functions, monitoring execution of the functions, logging metrics and events associated with the functions, managing fault tolerance for the functions, and/or other management tasks.

The serverless infrastructure includes an infrastructure layer implemented as a service mesh to connect functions. The infrastructure layer can include sidecars, which are helper modules for the functions that perform respective additional tasks of the service mesh for the functions. In some cases, the sidecars use kernel networking to perform communications. A kernel is the core of an operating system (OS), and kernel networking uses a kernel protocol stack to handle the routing and forwarding of data packets between the functions. However, kernel networking may be associated with relatively high latency, which leads to delays in data communications between functions that may adversely impact the performance of the functions.

In accordance with some implementations of the present disclosure, data transfer across functions (that perform serverless workloads in a computing environment including multiple computing nodes) uses a distributed shared memory. In the ensuing discussion, a computing node on which functions are executable is referred to as a “worker node.” A data transfer between functions can include an intra-node data transfer if the functions are in the same worker node. In contrast, an inter-node data transfer involves a data transfer between functions on different worker nodes.

The intra- and inter-node data transfers of the computing environment including multiple worker nodes are performed through a data plane including the distributed shared memory. Functions running on the worker nodes can include a function chain of functions that process data in order. For example, the chain of functions can include a head function that is invoked first, followed by successive functions in the order. Note that a given function in the function chain can invoke multiple other functions in the function chain; the given function can provide the multiple other functions with output data generated by the given function. The data plane includes an intra-node data plane within a worker node and an inter-node data plane for data communications across worker nodes.

In some examples, the intra-node data plane of a worker node can include software accelerators associated with respective functions that run in the worker node. The software accelerators can perform intra-node data communications between the functions that run in the worker node using a local shared memory.

The inter-node data plane includes software gateways (node gateways) in respective worker nodes, which use RDMA NICs to perform RDMA-based transfers of data between functions running on different worker nodes. The node gateway on each worker node manipulates the RDMA NIC on behalf of the functions. For example, the node gateway of a worker node includes descriptor queues to store packet descriptors for data communications. A packet descriptor includes an identifier of a next function of the function chain to apply data processing, and a pointer to a memory location of the shared memory where the data to be processed is stored. The node gateway of the worker node also includes a router to perform an inter-node RDMA transfer of data from a first function on a source worker node to a second function of the function chain on a destination worker node.

In accordance with further implementations of the present disclosure, functionalities of a service mesh can be partitioned into different categories, and the functionalities of the different categories can be performed by respective different types of sidecars. The different categories of functionalities can include (1) on-path functionalities, and (2) off-path functionalities. “On-path” functionalities include functionalities performed on data packets in the communication path between functions, where the functionalities relate to routing of the data packets, load balancing to select a destination for the data packets (e.g., selecting an instance of a target function from among multiple instances of the target function to which the data packets are to be sent), converting (e.g., encrypting, compressing, etc.) the data packets such that the converted data packets are sent to a destination, traffic management (e.g., rate limiting, fault tolerance, etc.) of the data packets, and access control (e.g., intrusion detection, firewall, etc.) of the data packets. “Off-path” functionalities include ancillary functionalities performed with respect to the data packets, where the ancillary functionalities do not affect how and whether the data packets are transmitted to a destination, including any of the following: how the data packets are routed, load balancing, converting the data packets for delivery of the converted data packets to a destination, traffic management, and access control of the data packets. Examples of ancillary functionalities include any or some combination of the following: metric computation based on the data packets, computing observability based on the data packets, scalability computation based on the data packets, event generation based on the data packets, logging of the data packets, or other ancillary functionalities.

In some examples of the present disclosure, a first computing node includes a software accelerator executable on a central processing unit (CPU) of the first computing node to perform on-path handling of data communicated (transmitted or received) by the first computing node. The on-path handling includes processing the data in a communication path between the first computing node and a second computing node. The on-path handling includes on-path functionalities. The first computing node further includes a hardware accelerator separate from the CPU. A hardware accelerator-based sidecar is executable on the hardware accelerator to perform asynchronous processing of the data, where the asynchronous processing of the data is independent of the on-path handling of the data. The asynchronous processing of the data includes off-path functionalities. Performing the off-path functionalities on the hardware accelerator-based sidecar avoids performing such functionalities on sidecars of an infrastructure layer that execute on a CPU of the first computing node, which avoids adding overhead to the CPU that reduces the available processing capacity of the CPU for other tasks.

A “software accelerator” can refer to a module that assists in performing communication tasks for another entity in a computing node. An example of a software accelerator is an extended Berkeley Packet Filter (eBPF) sidecar program. An eBPF sidecar program can dynamically extend the functionality of an OS kernel, such as the Linux kernel, in a secure manner. The OS kernel has a verifier that can verify the program code of an eBPF sidecar program before the eBPF sidecar program can be installed to perform its functionalities. In other examples, other types of software accelerators can be employed, such as any of the following: a library-based sidecar developed as a library integrated with application code, a sidecar container including a sidecar program run in a container, or any other type of sidecar. A software accelerator may refer to an accelerator that executes on the CPU of a computing node.

The hardware accelerator on which the accelerator-based sidecar (e.g., a sidecar container or any other type of helper module executed by a processing resource of the hardware accelerator) is executable can include any or some combination of the following: a smart network interface controller (NIC), the Bluefield data processing unit (DPU) from Nvidia, an infrastructure processing unit (IPU) from Intel, or any other type of hardware accelerator that includes a processing resource to execute program code.

In some examples, the first computing node may further include a node gateway to perform certain on-path functionalities. In such examples, on-path functionalities of each worker node can include a first subset of on-path functionalities performed by the software accelerators associated with functions, and a second subset of on-path functionalities performed by the node gateway.

Separate Handling of on-Path and Off-Path Functionalities

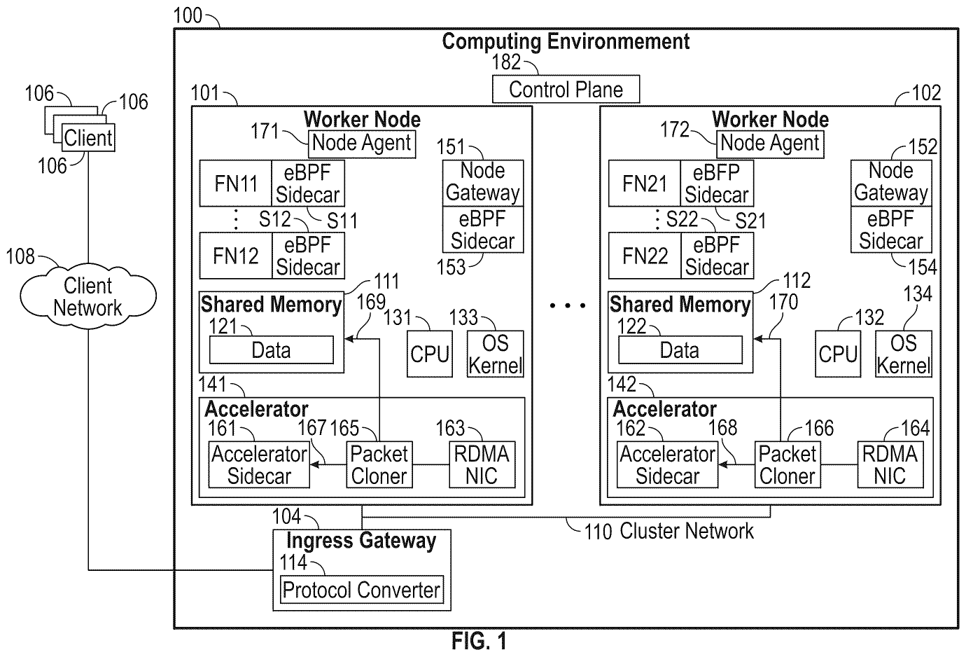

FIG. 1 is a block diagram of an example arrangement that includes worker nodes 101 and 102, an ingress gateway 104, and clients 106. A “client” can refer to an electronic device or a program executed in an electronic device. A “worker node” refers to a computing node that executes functions to perform target tasks. A function may include a user function, which refers to a function of an application program or any other type of program that a user can request to perform the target tasks. A “user” can refer to a human, a program, or a machine. A function may further refer to a function of another type of program, such as an OS, a management program, and so forth. Although FIG. 1 shows two worker nodes, in other examples, the computing environment 100 can include a different quantity of worker nodes (e.g., 1 worker node or more than 2 worker nodes).

A client 106 can send a data packet over a client network 108 to the computing environment 100. The computing environment 100 can include any of the following: a data center, a cloud computing environment (such as a serverless cloud computing environment), or any other type of computing environment. A “client network” is a network over which a client can connect to the computing environment 100. The client network 108 may include a public network such as the Internet, a local area network (LAN), a wide area network (WAN), or another type of network.

A client data packet received from a client 106 can be processed by a workload performed by one or more of the worker nodes 101 and 102. The client data packet can include one or more protocol headers defined by respective one or more network protocols, such as any or some combination of the following: the Hypertext Transfer Protocol (HTTP), the Transmission Control Protocol (TCP), the User Datagram Protocol (UDP), the File Transfer Protocol (FTP), or any other type of network protocol.

The ingress gateway 104 includes a protocol converter 114 that converts client data packets including protocol headers to cluster data packets that can be transferred over a cluster network 110 to the worker nodes 101 and 102. The cluster network 110 is a network of the computing environment 100 over which members of a node cluster (e.g., the worker nodes 101 and 102 as well as other members such as the ingress gateway 104 and a control plane 182) are able to communicate.

The protocol converter 114 can identify and remove the protocol headers of a client data packet to extract a data payload of the client data packet. The protocol converter 114 produces a cluster data packet to carry the data payload. The cluster data packet can include headers associated with communication protocols to transfer data to the worker nodes 101 and 102. For example, the headers in the cluster data packet can include headers associated with Remote Direct Memory Access (RDMA) transfers of data payloads (these headers are referred to as “RDMA-related headers”). A cluster data packet that includes RDMA headers is referred to as an “RDMA data packet.” An RDMA transfer of a data payload allows a source entity to write the data payload to a memory of a destination entity without involving a CPU of the destination entity (e.g., a CPU of a worker node). RDMA-related headers can include headers used in RDMA over Converged Ethernet (RoCE) communications, RDMA over InfiniBand communications, or other types of RDMA communications. Although reference is made to using RDMA for data transfers over the cluster network 110 with worker nodes in some examples, it is noted that other communication technologies can be used for data transfers over the cluster network 110, such as TCP or UDP communications.

In a specific example, the protocol converter 114 can strip protocol header HTTP and TCP headers from a client data packet to extract a data payload of the client data packet. The protocol converter 114 produces an RDMA data packet containing RDMA-related headers and the data payload, and the ingress gateway 104 sends the RDMA data packet using a RDMA transfer to a destination worker node 101 or 102.

By applying HTTP/TCP protocol processing (or another type of network protocol processing) of client data packets at the ingress gateway 104 allows the worker nodes 101 and 102 to not have to perform the HTTP/TCP protocol processing (or another type of network protocol processing). In this way, redundant network protocol processing in the worker nodes 101 and 102 can be avoided. Note that the network protocol processing can be applied at the ingress gateway 104 for both incoming client data packets (from the clients 106) and outgoing client data packets (sent from the computing environment 100 to the clients 106).

The worker node 101 includes a shared memory 111, and the worker node 102 includes a shared memory 112. A “shared memory” refers to a memory that is shared by multiple entities, which in this case include functions and other entities of each worker node. A memory can be implemented using one or more memory devices. The shared memory 111 is a local memory of the worker node 101, and the shared memory 112 is a local memory of the worker node 102. Collectively, the shared memories 111 and 112 (and any other shared memories of other respective worker nodes) can form a distributed shared memory (discussed further below).

The worker node 101 includes functions FN11 and FN12, and the worker node 102 includes functions FN21 and FN22. Although two functions are shown in each worker node, it is noted that in other examples, a worker node can include a different quantity (1 or more than 2) functions. In some examples, a function can be implemented as a function container, which is a container that executes a function such as the user function of an application program or another type of program. In other examples, instead of executing functions in containers, functions can be executed in virtual machines (VMs) or as program modules that run on a CPU of the worker node.

The worker node 101 includes a CPU 131, and the worker node 102 includes a CPU 132. A “CPU” can include one or more hardware processors. The CPU of a worker node executes primary machine-readable instructions of the worker node. Primary machine-readable instructions can include an OS, system firmware, and application programs. The OS includes an OS kernel that forms the core of the OS. The worker node 101 includes an OS kernel 133 executable by the CPU 131, and the worker node 102 includes an OS kernel 133 executable by the CPU 132. The system firmware can include Basic Input/Output System (BIOS) code or Universal Extensible Firmware Interface (UEFI) code, for example. “Primary” machine-readable instructions are distinct (and separate) from machine-readable instructions (such as firmware or software) executable by other electronic components, such as an accelerator of a worker node.

The worker node 101 includes an accelerator 141, and the worker node 102 includes an accelerator 142. An “accelerator” can refer to a specialized processor that is separate and distinct from a CPU of a worker node. While the CPU is used to execute primary machine-readable instructions, the accelerator can include a processing resource that can perform computations independent of the CPU. The processing resource of the accelerator can include processing elements (e.g., processing cores) that perform computations in parallel.

A worker node can also include a node gateway to manage transfers of data between worker nodes and to manage processing of layer 7 headers and data encapsulated as RDMA payload.

Layer 7 is the top layer of the Open Systems Interconnection (OSI) model, and layer 7 includes the application layer. The worker node 101 includes a node gateway 151, and the worker node 102 includes a node gateway 152. A node gateway can include machine-readable instructions executed by a worker node. A layer 7 header includes a header of an application program, for example. Different application programs can employ different layer 7 headers.

A node gateway (e.g., 151 or 152) can receive an indication that an incoming data packet (e.g., an RDMA data packet or another type of cluster data packet) has been received at the worker node in which the node gateway executes. In response to the indication (which may be received from the ingress gateway 104 or from another worker node), the node gateway can trigger a function chain of functions (e.g., any combination of FN11, FN12, FN21, FN22) to be executed. A “function chain” refers to a workflow of functions that successively apply processing of data. The function chain can include a first function followed by a second function that executes after the first function. There may be additional functions in the function chain that execute after the second function. In some cases, the function chain can include multiple functions that execute in parallel. In some examples, a function chain can be represented by a directed acyclic graph (DAG) or with another representation (e.g., a text file, another type of graphical representation, etc.). A function chain can include functions within a single worker node or within multiple worker nodes.

Data to be handled by the node gateway and the functions of a worker node is stored in a shared memory region. For example, data 121 is stored in the shared memory 111 of the worker node 101, and data 122 is stored in the shared memory 112 of the worker node 102. Each function of the function chain can access the data in the shared memory region.

By using the shared memory region to store data for access by respective functions of the function chain, zero-copy processing of data can be performed by the function chain. Zero-copy processing refers to processing of data by multiple entities (such as the functions of the function chain) without making duplicate copies of the data. Zero-copy processing can speed up communications between functions and reduce the amount of resources dedicated for the communications.

Result data of the processing of data by functions in a given worker node can be retrieved by the node gateway of the given worker node from the shared memory in the given worker node. The node gateway can send the result data to the ingress gateway 104 for forwarding to a client 106, or to another worker node for further processing.

In accordance with some examples of the present disclosure, an accelerator in a worker node can execute a respective accelerator sidecar to perform off-path functionalities for functions. The accelerator 141 executes an accelerator sidecar 161, and the accelerator 142 executes an accelerator sidecar 162. An accelerator sidecar is implemented with machine-readable instructions that are executed by a processing resource of the accelerator.

Each accelerator also includes an RDMA NIC that is the interface to receive RDMA data packets, such as from the ingress gateway 104 or from another worker node. The accelerator 141 includes an RDMA NIC 163, and the accelerator 142 includes an RDMA NIC 164. An RDMA NIC extracts a data payload from an RDMA data packet, and the RDMA NIC outputs the extracted data payload for further processing.

In some examples of the present disclosure, the extracted data payload is provided by the RDMA NIC to a packet cloner in an accelerator. The accelerator 141 includes a packet cloner 165, and the accelerator 142 includes a packet cloner 166. A packet cloner can be implemented with machine-readable instructions executed by the processing resource of the accelerator.

The packet cloner can mirror (duplicate) the extracted data payload received from a respective RDMA NIC. In the worker node 101, the packet cloner 165 in the accelerator 141 duplicates the extracted data payload from the RDMA NIC 163 to produce a first instance of the extracted data payload (first data payload instance 167) sent to the accelerator sidecar 161, and a second instance of the extracted data payload (second data payload instance 169) written to the shared memory 111. Similarly, in the worker node 102, the packet cloner 166 in the accelerator 142 duplicates the extracted data payload from the RDMA NIC 164 to produce a first instance of the extracted data payload (first data payload instance 168) sent to the accelerator sidecar 162, and a second instance of the extracted data payload (second data payload instance 170) written to the shared memory 112.

A packet cloner can also apply data mirroring for an outbound data packet to be transmitted by a worker node. For the outbound data packet, the packet cloner can create multiple instances of an outbound data payload of the outbound data packet, the multiple instances of the outbound data payload including a first instance of the outbound data payload provided to an accelerator sidecar, and a second instance of the outbound data payload provided to a destination.

Each accelerator sidecar 161 or 162 can apply off-path functionalities to the respective data payload. Such off-path functionalities are part of the asynchronous processing of data that can be performed by each accelerator sidecar. The asynchronous processing of the data is separate and independent from the processing of data performed by the node gateway and functions (and their respective software accelerators) in a worker node.

Examples of the off-path functionalities include any or some combination of the following: metric computation based on the data packets, computing observability based on the data packets, scalability computation based on the data packets, event generation based on the data packets, logging of the data packets, or other ancillary functionalities. A metric computation can compute one or more metrics based on the data packets, such as calculating a count of how many data packets have been encountered, calculating a rate of the data packets, or other metrics. Observability computation can include logging, tracing, and recording events in data traffic, for gaining visibility into the state and behavior of application programs. Scalability computation refers to generating a representation of a load so that resources of a worker node can be adjusted based on the load.

The data payload instance written to a shared memory of a worker node by a corresponding packet cloner is accessible to the node gateway and the functions of the function chain in the worker node. For example, the second data payload instance 169 written to the shared memory 111 is accessible to the node gateway 151 and functions FN11 and FN12 in the worker node 101. Similarly, the second data payload instance 170 written to the shared memory 112 is accessible to the node gateway 151 and functions FN21 and FN22 in the worker node 102.

On-path functionalities are applied by a node gateway and software accelerators associated with functions in a worker node. In some examples, the software accelerators include eBPF sidecars. In other examples, a software accelerator can include a library-based sidecar or another type of sidecar.

In the worker node 101, the node gateway 151 is associated with an eBPF sidecar 153, and functions FN11 and FN12 are associated with respective eBPF sidecars S11 and S12. Similarly, in the worker node 102, the node gateway 152 is associated with an eBPF sidecar 154, and functions FN21 and FN22 are associated with respective eBPF sidecars S21 and S22. A software accelerator (e.g., an eBPF sidecar) is associated with a node gateway or a function if the node gateway or the function is provided with information of the software accelerator so that the software accelerator can be used to perform communications. More specifically, a communication path (e.g., in the form of a socket, for example) is established between the node gateway or function and the respective software accelerator. As noted above, an eBPF sidecar can dynamically extend the functionality of an OS kernel (e.g., 133 or 134). The eBPF sidecar can be part of a socket that is accessible to the respective node gateway or function, such as through the use of a socket call.

A node gateway uses its associated software accelerator to communicate with a function through a software accelerator associated with the function. Similarly, a first function uses its associated software accelerator to communicate with a second function through the software accelerator associated with the second function.

The software accelerators are executed by the CPU of the respective worker node. Specifically, the eBPF sidecar 153 and the eBPF sidecars S11 and S12 are executed by the CPU 131 of the worker node 101, and the eBPF sidecar 154 and the eBPF sidecars S21 and S22 are executed by the CPU 131 of the worker node 102.

On-path functionalities that can be performed by the eBPF sidecars (e.g., S11, S12, S21, S22, 153, 154) can include routing of data packets and load balancing to select a destination for the data packets (e.g., selecting an instance of a target function from among multiple instances of the target function to which the data packets are to be sent). The node gateways 151 and 152 can perform more processing intensive on-path functionalities, such as converting (e.g., encrypting, compressing, etc.) the data packets such that the converted data packets are sent to a destination, traffic management (e.g., rate limiting, fault tolerance, etc.) of the data packets, and access control (e.g., intrusion detection, firewall, etc.) of the data packets.

Within the computing environment 100, the software accelerators (e.g., eBPF sidecars), the node gateways, the accelerator sidecars, the packet cloners, and the RDMA NICs of the worker nodes 101 and 102 form a data plane through which data payloads can be communicated among functions. In some examples, the data plane of each worker node is effectively partitioned into three components: (1) an accelerator that includes an RDMA NIC and an accelerator sidecar, (2) a node gateway, and (3) software accelerators associated with functions. Such partitioning allows an efficient use of CPU and accelerator resources for the data plane.

The control plane 182 of the computing environment 100 performs various control functionalities with respect to the worker nodes. The control plane 182 includes a controller (not shown). The control plane 182 interacts with node agents 171 and 172 in the respective worker nodes 101 and 102 to perform the control functionalities. The control plane 182 can receive a function chain creation request for creating a function chain from a user. In response to the function chain creation request, the control plane 182 can instruct one or more node agents 171 and 172 to create and assign resources for the function chain to be created. The assigned resources include memory resources (of a shared memory) and node gateway resources, for example. The control plane 182 can start up the functions of the function chain based on configuration information. The control plane 182 also triggers the creation of the software accelerators (e.g., eBPF sidecars) for respective functions.

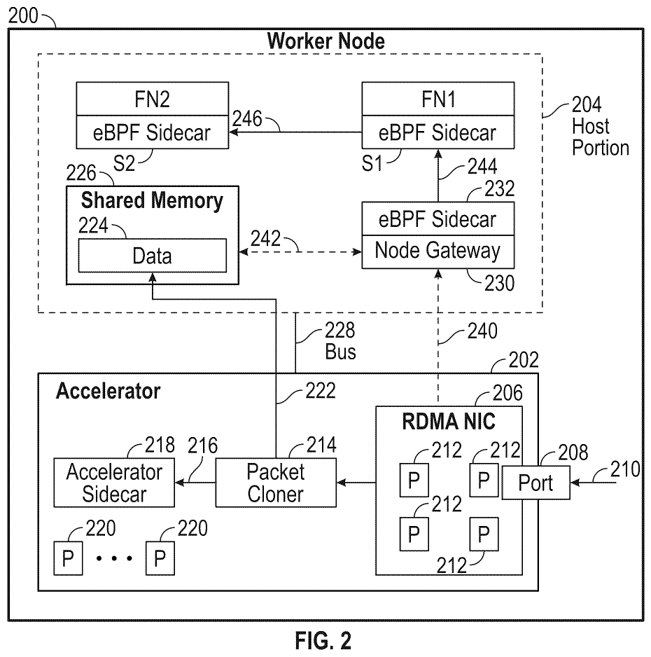

FIG. 2 is a block diagram of an example worker node 200, which can be the worker node 101 or 102 of FIG. 1, for example. The worker node 200 includes an accelerator 202 and a host portion 204. The accelerator 202 has an RDMA NIC 206 with a port 208 to receive and transmit RDMA data packets. The port 208 can be connected to the cluster network 110 of FIG. 1, for example. An incoming RDMA data packet 210 is received through the port 208 by the RDMA NIC 206. The incoming RDMA data packet 210 may be from the ingress gateway 104 or from another worker node.

The RDMA NIC 206 has processing elements 212 to handle RDMA data packets. The handling of the incoming RDMA data packet 210 includes extracting a data payload from the incoming RDMA data packet 210 and providing the extracted data payload to a packet cloner 214. The packet cloner 214 outputs a first data payload instance 216 to an accelerator sidecar 218 that can execute on processing elements 220 of the accelerator 202. The packet cloner 214 outputs a second data payload instance 222 and writes the second data payload instance 222 to a shared memory 226 in the host portion 204. The second data payload instance 222 is written as data 224 in the shared memory 226.

The accelerator 202 is connected over a bus 228 to the host portion 204. The bus 228 may be a Peripheral Component Interconnect Express (PCIe) bus, an Enhanced Serial Peripheral Interface (eSPI) bus, a Compute Express Link (CXL) bus, or any other type of interconnect between electronic components in a computer system.

The accelerator processing elements 220 can execute the accelerator sidecar 218 to asynchronously apply the off-path functionalities without adding delay to data processing of data in the host portion, including data processing by a node gateway 230 and functions FN1 and FN2 in the host portion 204.

The node gateway 230 is associated with an eBPF sidecar 232, and the functions FN1 and FN2 are associated with respective eBPF sidecars S1 and S2. In the example of FIG. 2, in response to the incoming RDMA data packet 210, the RDMA NIC 206 sends an indication 240 of the receipt of the incoming RDMA data packet 210 to the node gateway 230. The indication 240 can be in the form of a signal (e.g., an interrupt signal), a message, or any other information element. In response to the indication 240, the node gateway 230 retrieves (at 242) the data 224 from the shared memory 226. The data 224 includes the second data payload instance 222 provided by the packet cloner 214.

The node gateway 230 applies certain on-path functionalities on the retrieved data 224. After processing the retrieved data 224, the node gateway 230 writes the processed data to the shared memory 226. The node gateway 230 uses its eBPF sidecar 232 to send (at 244) a notification (e.g., a signal, a message, or another information element) to function FN1 through eBPF sidecars 232 and S1. The notification indicates that data is available in the shared memory 226 for processing by function FN1. After further processing of the data by function FN1, function FN1 writes the further processed data to the shared memory 226, and function FN1 sends (at 246) a further notification to function FN2 through eBPF sidecars S1 and S2. The further notification indicates that data is available in the shared memory 226 for processing by function FN2. If there are further functions in the function chain, function FN2 can send an additional notification to the next function in the function chain.

Each notification sent between eBPF sidecars (232, S1, and S2) includes a packet descriptor, which is a relatively small information element. A packet descriptor includes an identifier of a next function of the function chain to apply processing of data, and a reference to a memory location of the shared memory where the data to be processed by the next function is stored. Because on-path functionalities applied by the eBPF sidecars 232, S1, and S2 are based on packet descriptors that are relatively small (a descriptor includes certain metadata but not the actual data itself), the processing applied by the eBPF sidecars (or other software accelerators) does not consume significant processing resources of a CPU. The actual data (which can be much larger than a packet descriptor) is untouched by an eBPF sidecar.

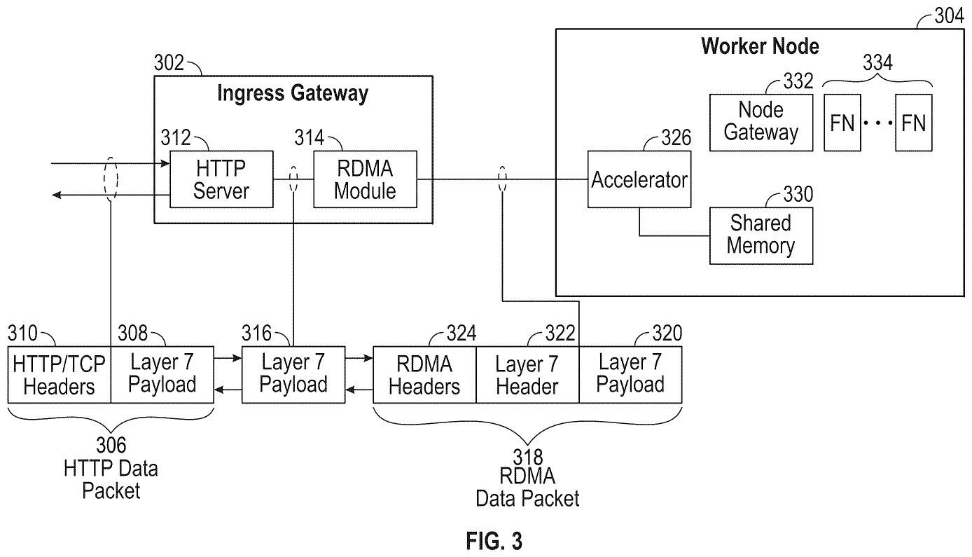

FIG. 3 is a block diagram of an arrangement that Includes an ingress gateway 302 and a worker node 304 according to some examples of the present disclosure. The worker node 304 can be either the worker node 101 or 102 of FIG. 1. The ingress gateway 302 can be the ingress gateway 104 of FIG. 1.

In some examples, it is assumed that a client data packet communicated with a client (e.g., 106 in FIG. 1) is an HTTP data packet 306. The HTTP data packet 306 includes a layer 7 payload 308 and HTTP and TCP headers 310, for example.

The ingress gateway 302 includes an HTTP server 312 that handles HTTP data packets received from clients or transmitted to clients. The following refers to an example of handling an incoming HTTP data packet 306. The HTTP server 312 can remove the HTTP and TCP headers 310 from the incoming HTTP data packet 306 to extract the layer 7 payload 308. The HTTP server 312 provides a layer 7 payload 316 (which is the layer 7 payload 308) to an RDMA module 314 of the ingress gateway 302. The RDMA module 314 produces an RDMA data packet 318 that includes a layer 7 payload 320 (which is the layer 7 payload 316), a layer 7 header 322, and RDMA headers 324. The content of the layer 7 header 322 can be determined at the ingress gateway 302 based on which worker node and function chain the RDMA data packet 318 is targeted to. The specific content of the layer 7 header 322 is application specific and can differ for different applications. In some cases, the layer 7 header 322 may be omitted.

Collectively, the HTTP server 312 and the RDMA module 314 (which can be implemented with machine-readable instructions) form the protocol converter 114 of FIG. 1, for example. If client data packets are according to network protocols different from HTTP, then the ingress gateway 302 can include different protocol processing modules for handling such client data packets.

Although just one instance of the HTTP server 312 in the RDMA module 314 are shown in the ingress gateway 302 of FIG. 3, in other examples, multiple instances of the HTTP server 312 and/or multiple instances of the RDMA module 314 can be provided in the ingress gateway 302. For example, the multiple instances of the HTTP server 312 and the RDMA module 314 can be executed on respective different processors or different computing nodes. Executing the HTTP server instances and the RDMA module instances across multiple processors and/or computing nodes can distribute the processing load of the ingress gateway 302 across processing resources. The dynamic scaling of the quantity of HTTP server instances and RDMA module instances can be based on the rate of incoming traffic.

The ingress gateway 302 in some examples forms a computing environment-wide translation point between HTTP/TCP-based traffic and RDMA-based traffic. An HTTP/TCP connection can be terminated at the HTTP server 312. By terminating HTTP/TCP connections at the ingress gateway 302 and enabling RDMA-based communications with worker nodes, HTTP/TCP protocol processing can be centralized at the ingress gateway 302 and does not have to be performed by the worker nodes. Avoiding HTTP/TCP protocol processing (or other network protocol processing) at the worker nodes reduces processing and communications overhead and can improve the performance of the worker nodes.

The RDMA module 314 sends the RDMA data packet 318 to the worker node 304. The worker node 304 includes an accelerator 326, which can be the accelerator 141 or 142 of FIG. 1, for example. The accelerator 326 can include an RDMA NIC, a packet cloner, and an accelerator sidecar.

The accelerator 326 writes the layer 7 payload 320 to a shared memory 330 in the worker node 304. The data in the shared memory 330 is accessible to a node gateway 332 and functions of a function chain 334 in the worker node 304.

In the reverse direction (a data packet to be sent from the worker node 304 to a client), the RDMA module 314 receives the RDMA data packet 318 from the worker node 304. The RDMA module 314 extracts the layer 7 payload 320, and sends the layer 7 payload 316 to the HTTP server 312. The HTTP server 312 generates the HTTP data packet 306 that is sent to a client.

In some examples, I/O rate matching can be performed between HTTP servers and RDMA modules. The HTTP server 312 applies relatively heavyweight protocol processing, which consumes a higher processing load. In contrast, the processing by the RDMA module 314 consumes a lower processing load. This leads to a mismatch in resource requirements and processing rate between the HTTP server 312 and the RDMA module 314. In some examples, asynchronous I/O can be implemented to separate the handling of HTTP data packets by the HTTP server 312 and the RDMA processing of RDMA module 314. The HTTP server 312 and the RDMA module 314 can be perform independent processes to increase the flexibility of resource allocation. Asynchronous I/O allows the HTTP server 312 to initiate an I/O operation to the RDMA module 314 and continue processing HTTP traffic from external clients while waiting for the I/O operation to complete, and vice versa. Since the HTTP server 312 and the RDMA module 314 are not idling while waiting for the peer to complete the I/O operation, processing resources are utilized more efficiently.

Some examples of the present disclosure can provide the following benefits. Load on worker node CPUs can be reduced by performing off-path functionalities in accelerators. The accelerators may already be present in worker nodes of a computing environment. Accordingly, techniques or mechanisms according to some examples of the present disclosure can be applied with such accelerators without having to deploy new hardware. Both vertical and horizontal scalability can be achieved using the ingress gateway and worker nodes according to some examples of the present disclosure. Vertical scalability can be achieved by dynamically increasing or decreasing the number of instances of the protocol converter 114 (FIG. 1) (which may include an HTTP server and RDMA module, for example) based on traffic load, where the instances of the protocol converter 114 can be executed across processors or computing nodes. The use of asynchronous I/O between the HTTP server and the RDMA module allows for flexible resource allocation and processing of data. In some examples, different function chains may be associated with different tenants of a computing environment. A tenant of the computing environment refers to a user (or group of users) that have access to the resources and services of the computing environment. Complexity in implementing service meshes to connect functions can be reduced by employing sidecars such as eBPF sidecars.

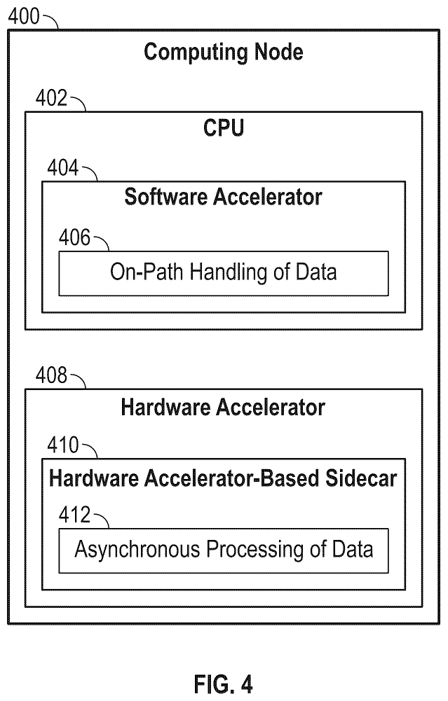

FIG. 4 is a block diagram of a computing node 400 according to some examples of the present disclosure. The computing node 400 may be the worker node 101 or 102 of FIG. 1, for example.

The computing node 400 includes a CPU 402 and a software accelerator 404. The software accelerator 404 can include an eBPF sidecar or another type of sidecar. In further examples, the software accelerator 404 can execute in a kernel context (the kernel space in which an OS kernel runs). The software accelerator 404 is executable on the CPU 402 to perform on-path handling (406) of data communicated (transmitted or received) by the computing node 400. The on-path handling (406) includes processing the data in a communication path between the computing node 400 and another computing node.

The computing node 400 further includes a hardware accelerator 408 separate from the CPU 402. A hardware accelerator-based sidecar 410 is executable on the hardware accelerator 408 to perform asynchronous processing (412) of the data. The asynchronous processing (412) includes off-path handling of data, and the asynchronous processing (412) is independent of the on-path handling (406) of the data.

In some examples, the asynchronous processing of the data includes one or more of metric computation based on the data, computing observability based the data, scalability computation based the data, event generation based on the data, or logging of the data.

In some examples, the on-path handling of the data performed by the software accelerator includes one or more of data routing or load balancing.

In some examples, the hardware accelerator-based sidecar 410 is a sidecar container executed on a processing resource of the hardware accelerator 408.

In some examples, a plurality of functions are executable by the CPU 402. The software accelerator 404 is a first software accelerator associated with a first function of the plurality of functions. The first software accelerator performs the on-path handling (406) of the data for the first function. The computing node 400 further includes a second software accelerator associated with a second function of the plurality of functions. The second software accelerator performs on-path handling of data for the second function.

In some examples, the plurality of functions are part of containers executable by the CPU 402.

In some examples, the computing node 400 includes a shared memory accessible to the first function and the second function. The first software accelerator is to send a notification to the second software accelerator that data is available in the shared memory for processing by the second function.

In some examples, the plurality of functions are part of a function chain, and the notification includes an identifier of a next function of the function chain to apply processing of data, and a reference to a memory location of the shared memory where the data to be processed by the next function is stored.

In some examples, the function chain includes functions across a plurality of computing nodes including the first and second computing nodes.

In some examples, the hardware accelerator-based sidecar 410 performs the asynchronous processing of the data for the plurality of functions.

In some examples, the on-path handling by the software accelerator 404 includes a first subset of on-path functionalities. The computing node 400 further includes a gateway to perform a second subset of on-path functionalities different from the first subset of on-path functionalities.

In some examples, the second subset of on-path functionalities includes converting (e.g., encrypting or decrypting, compressing or decompressing, etc.) data, access control of data, or traffic management for data.

In some examples, the computing node 400 includes a data cloner (e.g., 165, 166 in FIG. 1 or 214 in FIG. 2) to apply data mirroring of an incoming data packet received by the first computing node. The data mirroring creates multiple instances of a data payload of the incoming data packet. The multiple instances of the data payload includes a first instance of the data payload provided to the hardware accelerator-based sidecar, and a second instance of the data payload provided to host software of the first computing node. The host software can include a node gateway and functions and associated software accelerators, for example.

In some examples, the data cloner applies further data mirroring for an outbound data packet to be transmitted by the first computing node. The further data mirroring creates multiple instances of an outbound data payload of the outbound data packet, the multiple instances of the outbound data payload including a first instance of the outbound data payload provided to the hardware accelerator-based sidecar, and a second instance of the outbound data payload provided to a destination. The destination may be another worker node or the ingress gateway 104 (FIG. 1).

In some examples, the hardware accelerator includes an RDMA NIC to perform RDMA transfers over a cluster network with another computing node or with the ingress gateway that interacts with clients.

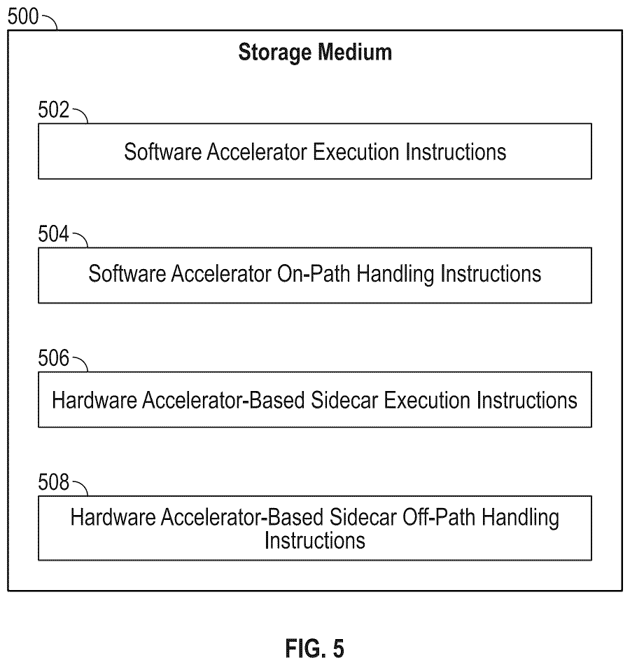

FIG. 5 is a block diagram of a non-transitory machine-readable or computer-readable storage medium 500 storing machine-readable instructions that upon execution cause a system to perform various tasks. The system can include a computing node or a collection of computing nodes.

The machine-readable instructions include software accelerator execution instructions 502 to execute software accelerators that are associated with functions of a computing node. The software accelerators communicate descriptors for indicating availability of data in a shared memory for processing by the functions.

The machine-readable instructions include software accelerator on-path handling instructions 504 to perform on-path handling of the data by the software accelerators. The on-path handling can include one or more of data routing or load balancing.

The machine-readable instructions include hardware accelerator-based sidecar execution instructions 506 to execute a hardware accelerator-based sidecar in a hardware accelerator of the computing node. The hardware accelerator can include a NIC and additional processing elements to execute the hardware accelerator-based sidecar.

The machine-readable instructions include hardware accelerator-based sidecar off-path handling instructions 508 to perform off-path handling of the data using the hardware accelerator-based sidecar. The off-path handling of the data is independent of the on-path handling of the data.

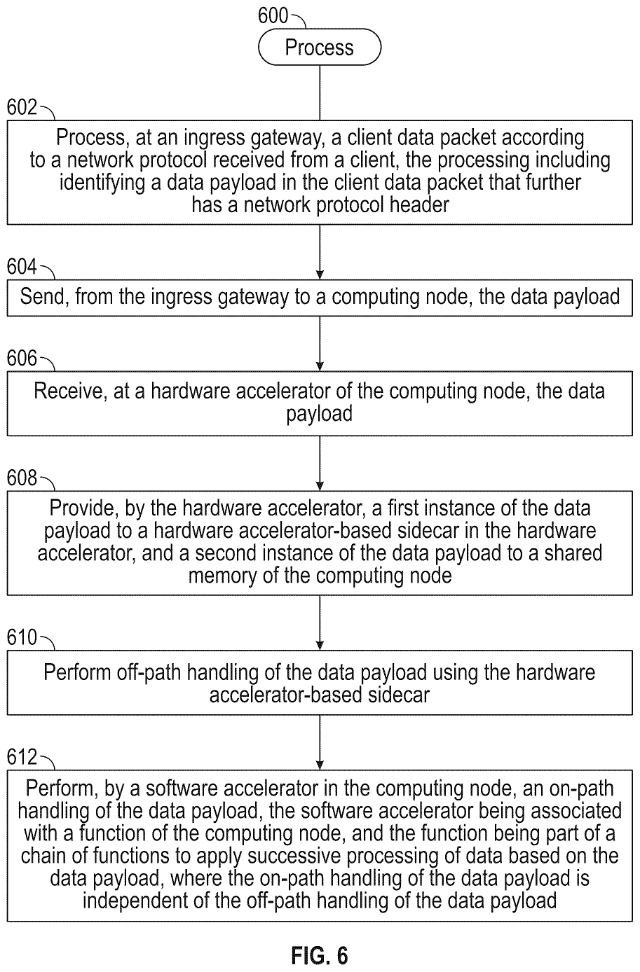

FIG. 6 is a flow diagram of a process 600 according to some examples of the present disclosure. The process 600 can be performed in a computing environment (e.g., 100 in FIG. 1).

The process 600 includes processing (at 602), at an ingress gateway, a client data packet according to a network protocol received from a client, the processing including identifying a data payload in the client data packet that further has a network protocol header. An example of the ingress gateway is the ingress gateway 104 of FIG. 1 or ingress gateway 302 of FIG. 3.

The process 600 includes sending (at 604), from the ingress gateway to a computing node, the data payload. In some examples, the data payload is sent in a data packet according to a transfer protocol, such as an RDMA protocol.

The process 600 includes receiving (at 606), at a hardware accelerator of the computing node, the data payload. The hardware accelerator includes a NIC to receive the data packet according to the transfer protocol, and the NIC can extract the data payload from the data packet.

The process 600 includes providing (at 608), by the hardware accelerator, a first instance of the data payload to a hardware accelerator-based sidecar in the hardware accelerator, and a second instance of the data payload to a shared memory of the computing node. The shared memory is accessible to functions in the computing node.

The process 600 includes performing (at 610) off-path handling of the data payload using the hardware accelerator-based sidecar.

The process 600 includes performing (at 612), by a software accelerator in the worker node, an on-path handling of the data payload, the software accelerator being associated with a function of the computing node, and the function being part of a chain of functions to apply successive processing of data based on the data payload, where the on-path handling of the data payload is independent of the off-path handling of the data payload.

### Data Plane

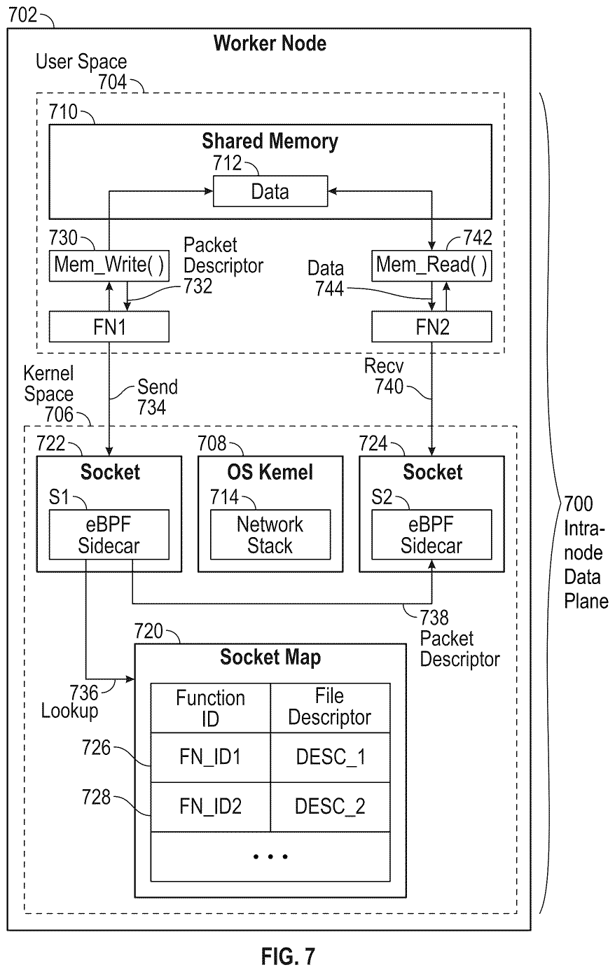

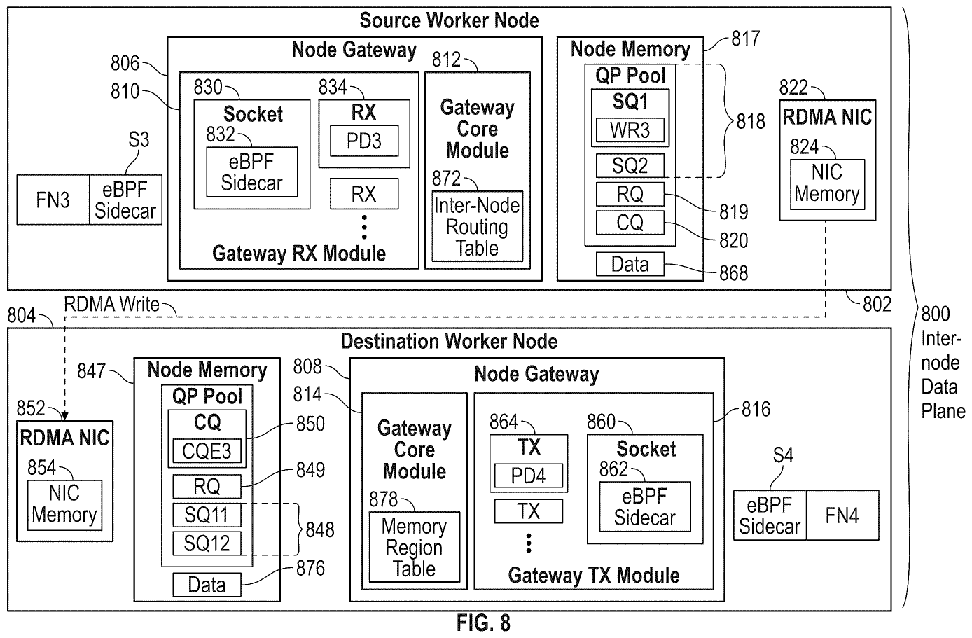

A data plane of a computing environment (e.g., 100 in FIG. 1) includes an intra-node data plane for communications between functions within a worker node, and an inter-node data plane for communications between functions on different worker nodes. FIG. 7 is a block diagram of an intra-node data plane 700 in a worker node 702 (e.g., 101 or 102 in FIG. 1). FIG. 8 is a block diagram of an inter-node data plane 800 for communications between functions on different worker nodes.

### Intra-Node Data Plane

The worker node 702 includes a user space 704 and a kernel space 706. The kernel space 706 refers to an address space in which an OS kernel 708 (e.g., 133 or 134 in FIG. 1) executes. The user space 704 refers to an address space in which less privileged machine-readable instructions execute. The less privileged machine-readable instructions, such as application programs or other programs, run at a privilege level that is lower than a privilege level of the OS kernel 708. The user space 704 includes a shared memory 710 that stores data 712 accessible to functions FN1 and FN2 that execute in the user space 704.

The OS kernel 708 includes a kernel network stack 714 that executes in the kernel space 706. An example of the kernel network stack 714 is a TCP/IP (Transmission Control Protocol/Internet Protocol) stack for communicating TCP/IP packets.

The kernel space 706 further includes a socket map 720, which includes information correlating function identifiers (IDs) of functions (e.g., FN1 and FN2) to respective file descriptors. For example, the socket map 720 includes a first entry 726 that correlates a function ID FN_ID1 (that identifies FN1) to a first file descriptor (DESC_1), a second entry 728 that correlates a function ID FN_ID2 (that identifies FN2) to a second file descriptor (DESC_2), and other entries. A function ID can be a numeric value, an alphanumeric value, or any other type of value that uniquely identifies a function in a computing environment. A file descriptor in a given entry of the socket map 720 includes target socket interface information that specifies a socket through which a function identified by a function ID in the given entry is accessible.

The socket map 720 contains function order information indicating an order of functions of a function chain. A control plane (e.g., the control plane 182 of FIG. 1) can populate the order information in the socket map 720 based on information of the function chain. The information of the function chain may be in the form of a DAG, for example. In examples where eBPF sidecars are used, the socket map 720 can be in the form of an eBPF sockmap. The sockmap is a special eBPF map (BPF_MAP_TYPE_SOCKMAP) that keeps references to socket interfaces.

In some examples, the OS kernel 708 presents sockets 722 and 724. A socket is an interface that allows programs to communicate with one another. The socket 722 includes an eBPF sidecar S1 (or another type of software accelerator) accessible to function FN1, and the socket 724 includes an eBPF sidecar S2 (or another type of software accelerator) accessible to function FN2. More specifically, in some examples, the eBPF sidecar S1 is attached to a kernel hook point of the socket 722, and the eBPF sidecar S2 is attached to a kernel hook point of the socket 724.

Function FN1 accesses the eBPF sidecar S1 by accessing the socket 722 by issuing a socket call. Similarly, function FN2 accesses the eBPF sidecar S2 by accessing the socket 724 by issuing a socket call.

The following describes an example of a data flow from function FN1 to function FN2. Function FN1 issues a memory write command to write the data 712 to the shared memory 710. The memory write command triggers the execution of a mem_write( ) routine 730, which writes the data 712 to a memory buffer of the shared memory 710. The data 712 written to the memory buffer can include a data packet, for example. The shared memory 710 can include multiple memory buffers to store respective data for respective functions (or other entities).

The mem_write( ) routine returns a packet descriptor 732 for the data 712 to function FN1 after completing the write. In some examples, a packet descriptor can include the following information: a function ID of the next function in a function chain that is to be invoked for processing data, and a pointer to the data accessible to the next function in the shared memory 710. A “pointer” can include information that can be used to identify a storage location of the data 712 in the shared memory 710. For example, the pointer can include an address or an address offset.

Use of packet descriptors enables zero-copy data movement between functions. A packet descriptor passes the pointer to data in the shared memory 710, and the pointer is used by the next function in the function chain to access the data. As a result, a copy of the data does not have to be made for passing between functions.

The packet descriptor 732 includes the function ID FN_ID2 of function FN2, which is assumed to be the next function of the function chain in this example. The packet descriptor 732 further includes a pointer to the data 712 in the shared memory 710. The mem_write( ) routine 730 can access the socket map 720 to determine which function follows function FN1 that issued the memory write command.

After receiving the packet descriptor 732, function FN1 issues a send socket call 734 to the socket 722 for transferring the data 712 stored in the shared memory 710. The send socket call 734 refers to a socket call for sending data to another function. The send socket call 734 includes the packet descriptor 732.

The send socket call 734 triggers the execution of the eBPF sidecar S1 for intra-node data communication between functions. The eBPF sidecar S1 extracts the function ID (e.g., FN_ID2) of the next function (e.g., FN2) from the packet descriptor 732. The eBPF sidecar S1 uses the function ID of the next function to perform a lookup (736) of the socket map 720 to retrieve the respective file descriptor. In this example, the lookup based on FN_ID2 retrieves the entry 728, which contains file descriptor DESC_2 containing the target socket interface information of the socket 724.

Once the eBPF sidecar S1 has identified the socket 724 based on the lookup (736), the eBPF sidecar S1 sends a packet descriptor 738 to the eBPF sidecar S2 in the socket 724. The packet descriptor 738 is the same as the packet descriptor 732 received by the eBPF sidecar S1 from function FN1. The packet descriptor 738 can be included in a socket call from the eBPF sidecar S1 to the socket 724. The socket call from the eBPF sidecar S1 is a socket call for sending information between eBPF sidecars. By using such a socket call, the communication between functions using the eBPF sidecars S1 and S2 bypasses the network stack 714 of the OS kernel 708. This reduces latency and resource usage associated with data communications between functions, since the relatively heavyweight processing of the network stack 714 is skipped. Each eBPF sidecar implements a socket message program that is able to transfer information between the eBPF sidecars within a worker node (an intra-node data transfer).

Function FN2 issues a recv socket call 740 to the socket 724 to receive any information that is targeted to function FN2. In an example, the recv socket call 740 may be blocked by the OS kernel 708 while information for function FN2 is not available. However, in response to the transfer of the packet descriptor 738 to the socket 724, the OS kernel 708 can unblock the recv socket call 740 so that the eBPF sidecar S2 in the socket 724 can send the packet descriptor 738 to function FN2.

After receiving the packet descriptor 738, function FN2 issues a memory read command to read the data 712 from the shared memory 710. The memory read command triggers the execution of a mem_read( ) routine 742, which reads the data 712 from the corresponding memory buffer of the shared memory 710. The mem_read( ) routine 742 returns data 744 to function FN2. The returned data 744 is the data 712 read from the shared memory 710.

At this point, function FN2 can apply processing on the data 744. The processed data can be written by function FN2 to the shared memory 710 (either to the same memory buffer that stores the data 712 or another memory buffer). Function FN2 can then perform a similar intra-node data transfer process to transfer the processed data to another function (if any) in the function chain.

### Inter-Node Data Plane

FIG. 8 is a block diagram of the inter-node data plane 800 for communications between functions FN3 and FN4 on different worker nodes. Function FN3 executes in a worker node 802, while function FN4 executes in a worker node 804. In the ensuing discussion, it is assumed that function FN3 sends data to function FN4. Thus, the worker node 802 is referred to as the source worker node 802, and the worker node 804 is referred to as the destination worker node 804.

In some examples, node gateways 806 and 808 in the respective source and destination worker nodes 802 and 804 coordinate zero-copy RDMA transfers between the source and destination worker nodes 802 and 804. The RDMA transfers also bypass OS kernel network stacks of the source and destination worker nodes 802 and 804.

Instead of configuring functions to initiate RDMA transfers, the node gateways are used to initiate RDMA transfers. In this way, developers of the functions do not have explicitly specify when inter-node RDMA transfers are to be employed, which can reduce the complexity of the functions. Also, the management of RDMA queue pairs (QPs) can be managed by the node gateway in each worker node to coordinate security and performance isolations of different RDMA transfers.

An RDMA QP is an interface between software and hardware. In some examples of the present disclosure, the software includes a node gateway of a worker node, and the hardware is an RDMA NIC of the worker node. To perform an inter-node RDMA transfer, the source and destination worker nodes 802 and 804 establish an RDMA reliable connection (RC) between the node gateway 806 of the source worker node 802 and the node gateway 808 of the destination worker node 804. A reliable connection refers to a transport service type in which messages are sent in a reliable way (in terms of the correctness and order of the messages).

A QP is the communication endpoint that a node gateway uses to interact with the RDMA NIC. A QP includes an RDMA send queue and an RDMA receive queue. For an active reliable connection, the related QPs of a worker node are loaded from the host memory of the worker node to the memory of the RDMA NIC.

In some examples, a node gateway includes the following modules: a gateway receive (RX) module, a gateway transmit (TX) module, and a gateway core module. A “module” can refer to a thread, a process, or any other unit of execution. The gateway RX module is responsible for receiving a packet descriptor from a function, and the gateway TX module is responsible for transmitting a packet descriptor to a function.

The node gateway 806 includes a gateway RX module 810 and a gateway core module 812. The gateway TX module of the node gateway 806 is not shown since the gateway TX module of the node gateway 806 is not involved in the inter-node RDMA transfer from the source worker node 802 to the destination worker node 804.

The node gateway 808 includes a gateway core module 814 and a gateway TX module 816. The gateway RX module of the node gateway 808 is not shown since the gateway RX module of the node gateway 808 is not involved in the inter-node RDMA transfer from the source worker node 802 to the destination worker node 804.

The source worker node 802 further includes a node memory 817 in which a QP pool including RDMA send queues (SQs) 818, a shared RDMA receive queue (RQ) 819, and a shared completion queue (CQ) 820 are stored. The source worker node 802 additionally includes an RDMA NIC 822. The RDMA NIC 822 may be part of a hardware accelerator (e.g., 141 or 142 in FIG. 1). The RDMA NIC 822 includes a NIC memory 824 to store information used for RDMA transfers. The NIC memory 824 can store one or more QPs for respective active reliable connections.

In the source worker node 802, function FN3 can communicate with the gateway RX module 810 through a socket 830 associated with the gateway RX module 810. The socket 830 includes an eBPF sidecar 832 (e.g., 152 or 154 in FIG. 1). The gateway RX module 810 includes a receive (RX) queue 834 assigned to function FN3. The gateway RX module 810 may include additional RX queues assigned to other functions. The RX queue 834 stores a packet descriptor PD3 provided by function FN3. Although not shown, the gateway TX module of the node gateway 806 includes a transmit (TX) queue assigned to function FN3, as well as additional TX queues assigned to other functions. The RX and TX queues of the node gateway 806 may be stored in the node memory 817.

The destination worker node 804 further includes a node memory 847 in which a QP pool including SQs 848, a shared RQ 849, and a shared CQ 850 are stored. The destination worker node 804 additionally includes an RDMA NIC 852.

The RDMA NIC 852 may be part of a hardware accelerator (e.g., 141 or 142 in FIG. 1). The RDMA NIC 852 includes a NIC memory 854 to store information used for RDMA transfers. The NIC memory 854 can store one or more QPs for respective active reliable connections.

In the destination worker node 804, function FN4 can communicate with the gateway TX module 816 through a socket 860 associated with the gateway TX module 816. The socket 860 includes an eBPF sidecar 862 (e.g., 152 or 154 in FIG. 1). The gateway RX module 810 includes a TX queue 864 assigned to function FN4. The gateway TX module 816 may include additional TX queues assigned to other functions. The TX queue 864 stores a packet descriptor (e.g., PD4) to be sent to function FN4. Although not shown, the gateway RX module of the node gateway 808 includes an RX queue assigned to function FN4, as well as additional RX queues assigned to other functions. The RX and TX queues of the node gateway 808 may be stored in the node memory 847.

Generally, the gateway TX and RX modules of a worker node include TX and RX queues for queuing packet descriptors associated with data packets that are to be transferred between worker nodes.

The gateway core module in a worker node is responsible for inter-node routing and interacting with QPs for the inter-node transfer of data. The gateway core module also manages the QP pool in the worker node. The gateway core module also establishes reliable connections between worker nodes and dynamically allocates QPs from the QP pool to functions based on their throughput and latency requirements. In some examples of the present disclosure, the inter-node transfer of data is performed using a one-sided RDMA write with immediate data, to accomplish zero-copy data transmission between worker nodes.

An RC QP in the source worker node 802 and an RC QP in the destination worker node 804 are used to establish a dedicated, point-to-point reliable connection between the node gateways 806 and 808 in the source and destination worker nodes 802 and 804. Each RC QP includes an RDMA SQ (send queue). Work requests are posted to an SQ. A work request can include a pointer referring to a memory buffer containing data to be sent. An example of a work request is an RDMA write. Another example of a work request is an RDMA read.

The RC QPs on a given worker node share an RDMA receive queue (RQ). Since one-sided RDMA is used in some examples of the present disclosure, the shared RQ is not used in a data transfer between worker nodes.

The RC QPs on the given worker node also share a completion queue (CQ). The sharing of the RQ and the CQ by QPs in a worker node reduces memory usage by the QPs. A CQ is used to store completion queue elements (CQEs) relating to work requests that have completed.

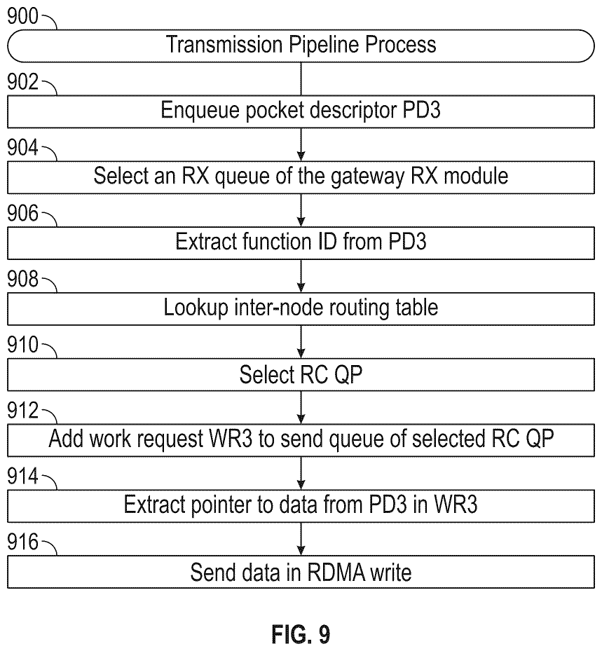

The following refers to FIG. 8 and FIG. 9. FIG. 9 is a flow diagram of a transmission pipeline process 900 at the source worker node 802 for transmitting data from function FN3 to another function (e.g., FN4).

To send data 868 stored in the node memory 817 of the source worker node 802 to function FN4 in the destination worker node 804, function FN3 enqueues (at 902) the packet descriptor PD3 to the RX queue 834 in the gateway RX module 810. This enqueuing of PD3 is accomplished based on function FN3 issuing a send socket call to trigger an eBPF sidecar S3 associated with FN3. The send socket call includes the packet descriptor PD3. The eBPF sidecar S3 sends the packet descriptor PD3 to the eBPF sidecar 832 of the socket 830. The gateway RX module 810 issues a recv socket call to obtain the packet descriptor PD, and the gateway RX module 810 adds the packet descriptor PD3 to the RX queue 834.

Because there may be multiple RX queues containing respective packet descriptors to be sent, the gateway core module 812 selects (at 904) one of the multiple RX queues of the gateway RX module 810 for transmission using a given queuing discipline. A queuing discipline controls which data in the multiple RX queues are to transmitted. Examples of queuing disciplines include first-in first-out (FIFO) queuing, priority queuing (PQ), weighted-fair queuing (WFQ), weighted round-robin queuing, and so forth.

Assuming that the gateway core module 812 has selected the RX queue 834, the gateway core module 812 reads the packet descriptor PD3 from the RX queue 834 and extracts (at 906) the function ID (e.g., FN_ID4) of the next function (e.g., FN4) from the packet descriptor PD3. The function ID (e.g., FN_ID4) in the packet descriptor PD3 identifies the destination function (e.g., FN4).

The gateway core module 812 includes an inter-node routing table 872, which may be stored in the source worker node memory 817. The inter-node routing table 872 contains entries that correlate function IDs to respective worker nodes. A first entry of the inter-node routing table 872 can correlate a first function ID to an identifier of a first worker node, a second entry of the inter-node routing table 872 can correlate a second function ID to an identifier of a second worker node, and so forth. The gateway core module 812 performs a lookup (at 908) of the inter-node routing table 872 using function ID FN_ID4 in the packet descriptor PD3 to retrieve an entry of the inter-node routing table 872. The retrieved entry contains the identifier of the destination worker node 804 in which function FN4 executes.

The gateway core module 812 selects (at 910) an RC QP to use for establishing a reliable connection with the destination worker node 804 identified by the retrieved entry. A reliable connection includes the RC QP at the source worker node 802 and an RC QP at the destination worker node 804. If multiple RC QPs are available at the source worker node 802, the gateway core module 812 can select the RC QP with the lowest quantity of outstanding work requests. Since the RC RQ 819 is shared, selecting the RC QP effectively refers to selecting one of the SQs 818. In the example of FIG. 8, it is assumed that the SQ selected is SQ1.

In other examples, the selection of an RC QP from multiple RC QPs can be based on other factors, such as requirements of a chain of functions relating to latency or throughput of data transfers.

After selecting SQ1, the gateway core module 812 encapsulates the packet descriptor PD3 into a work request WR3 and adds (at 912) the work request WR3 to SQ1 of the selected RC QP. The RDMA NIC 822 at the source worker node 802 retrieves the work request WR3 from SQ1 (note that a copy of SQ1 may be stored in the NIC memory 824 of the RDMA NIC 822) and extracts (at 914) the pointer to the data 868 from the packet descriptor PD3 in the work request WR3. The RDMA NIC 822 sends (at 916) the data 868 read from the node memory 817 and sends the data 868 in an RDMA write to the RDMA NIC 852 of the destination worker node 804.

This data transfer of the data 868 is part of a one-side RDMA write. As noted above, in some examples, a one-side RDMA write with immediate data is employed. The “immediate data” is sent by a source (in this case the source worker node 802) to a destination (in this case the destination worker node 804) with an RDMA write. Generally, the immediate data provides a notification to the destination that the RDMA write has occurred. In some examples of the present disclosure, the immediate data can include an identifier of a memory region in which the data transferred is stored (discussed further below).

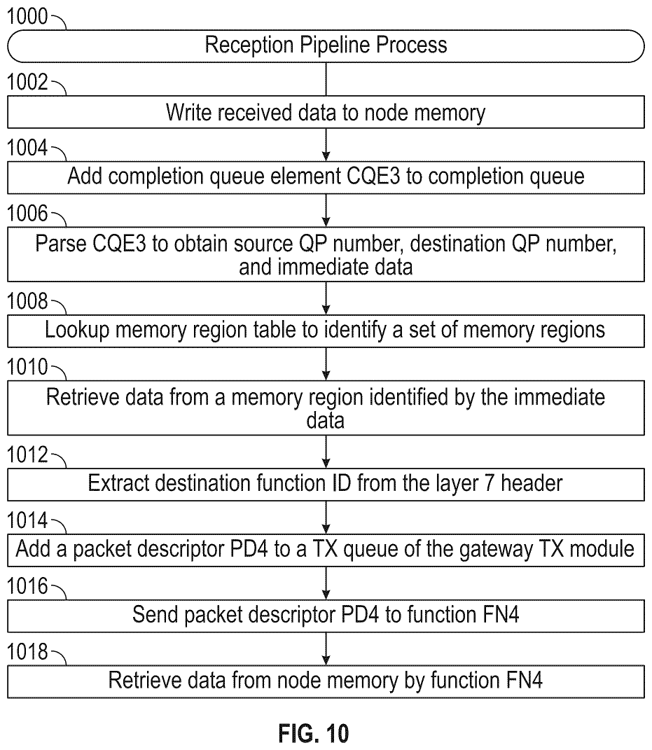

The following refers to FIG. 8 and FIG. 10. FIG. 10 is a flow diagram of a reception pipeline process 1000 at the destination worker node 804 for receiving data transmitted by the source worker node 802.

In response to receiving the data 868 from the source worker node 802, the RDMA NIC 852 of the destination worker node 804 writes (at 1002) the received data to the node memory 847 of the destination worker node 804. The received data is written as data 876 in the node memory 847. In response to writing the data 876 to the node memory 847, the RDMA NIC 852 generates a completion queue element (e.g., CQE3) that is added (at 1004) to the shared CQ 850. A completion queue element can include information that identifies a task (e.g., a work request) that was completed. A completion queue element may further include a source QP number (that identifies the QP of the source worker node 802), a destination QP number (that identifies the QP of the destination worker node 804), and immediate data that is sent with the RDMA write.

The gateway core module 814 reads CQE3 from the shared CQ 850 and parses (at 1006) CQE3 to obtain the following information: the source QP number (e.g., QP_3), the destination QP number (e.g., QP_4), and the immediate data (e.g., IMM1).

The source QP number and the destination QP number collectively form a key that can be used to perform a lookup (at 1008) of a memory region table 878 in the gateway core module 814. The memory region table 878 can be stored in the destination worker node memory 847. The memory region table 878 has entries that correlate keys (including respective combinations of source and destination port numbers) to respective sets of memory regions of the node memory 847. An example of the memory region table 878 is provided in Table 1 below.

TABLE 1

| Key: | |
|---|---|
| {Destination QP Number, | |
| Source QP Number} | Set of Memory Regions |
| {QP_4, QP_3} | {MR_1, MR_3, MR_4} |
| {QP_12, QP_628} | {MR_2, MR_5, MR_6, MR_10} |
| {QP_45, QP_3} | {MR_12} |
| . . . | . . . |

A first entry of the example memory region table 878 in Table 1 correlates the combination of destination QP_4 and source QP_3 to a set of memory regions {MR_1, MR_3, MR_4} in the destination worker node memory 847. Each memory region is identified by a memory region identifier. A “set” of memory regions can include one or more memory regions. Other entries of the example memory region table 878 correlates other QP number combinations to other sets of memory regions.

The memory region table 878 may be populated by the control plane 182 (FIG. 1), for example. The control plane 182 can configure specific memory regions to be used for corresponding reliable connections represented by respective combinations of destination QP numbers and source QP numbers.

In the above discussed example, CQE3 contains source QP number QP_3, destination QP number QP_4, and immediate data IMM1. The lookup (at 1008) of the memory region table 879 using {QP_4, QP_3} as the key retrieves the first entry that identifies the set of memory regions {MR_1, MR_3, MR_4}. The immediate data IMM1 includes a memory region identifier that identifies MR_4, for example. The gateway core module 814 retrieves (at 1010) the data 876 in the identified memory region MR_4 using the memory region identifier in IMM1.

The data 876 read from the memory region MR_4 is a data packet that includes a layer 7 header and a layer 7 payload, such as set forth in Table 2 below.

TABLE 2

| | | | | |
|---|---|---|---|---|
| Source Node | Destination | Source | Destination | Layer 7 |
| ID | Node ID | Function ID | Function ID | Payload |

In the above example data packet, the layer 7 header includes a source node ID (that identifies the source worker node 802), a destination node ID (that identifies the worker node 804), a source function ID (that identifies the source function FN3), and a destination function ID (that identifies the destination function FN4).

The gateway core module extracts (at 1012) the destination function ID from the layer 7 header. Since the discussed example assumes FN4 is the destination function, the destination function ID in the layer 7 header is FN_ID4. As discussed above, the TX queue 864 of the gateway TX module 816 is assigned to function FN4. Based on FN_ID4 extracted from the layer 7 header, the gateway core module 814 adds (at 1014) a packet descriptor (e.g., PD4) to the TX queue 864 of the gateway TX module 816 that is assigned to FN4. The packet descriptor PD4 is created by the gateway core module 814, and includes a function ID of the next function (if any) to process data, a pointer to the data 876 in the node memory 847.

The gateway TX module 816 is associated with a socket 880 that includes an eBPF sidecar 882. Function FN4 is also associated with an eBPF sidecar S4. The gateway TX module 816 sends (at 1016) the packet descriptor PD4 in the TX queue 864 to function FN4 via the eBPF sidecar 882 and the eBPF sidecar S4. Based on the packet descriptor PD4, function FN4 retrieves (at 1018) the data 876 from the node memory 847 and processes the data 876.

As discussed above, task 910 in the transmission pipeline process 900 of FIG. 9 selects an RC QP from multiple available RC QPs, which can be based on the quantity of work requests in respective SQs (send queues). The node gateway 806 (FIG. 8) in the source worker node 802 can track the quantity of outstanding work requests in each SQ. Based on this tracking the gateway core module 812 can balance workload across available reliable connections (available RC QPs). The gateway core module 812 may also create a new RC QP between the source worker node 802 and the destination worker node 804 in response to detecting an increased workload.

When a work request completes, a completion queue element (CQE) is generated and placed in the shared CQ 820. The gateway core module 812 obtains the CQE from the shared CQ 820 and compares the quantity of work requests in each SQ to the quantity of CQEs in the CQ. The quantity of outstanding work requests in each SQ can be estimated based on the comparison. When multiple

RC QPs share the same CQ, the QP number and work request identifier can be used to identify a RC QP and a specific work request the RC QP correspond to for updating the count of the quantity of work requests in the RC QP.

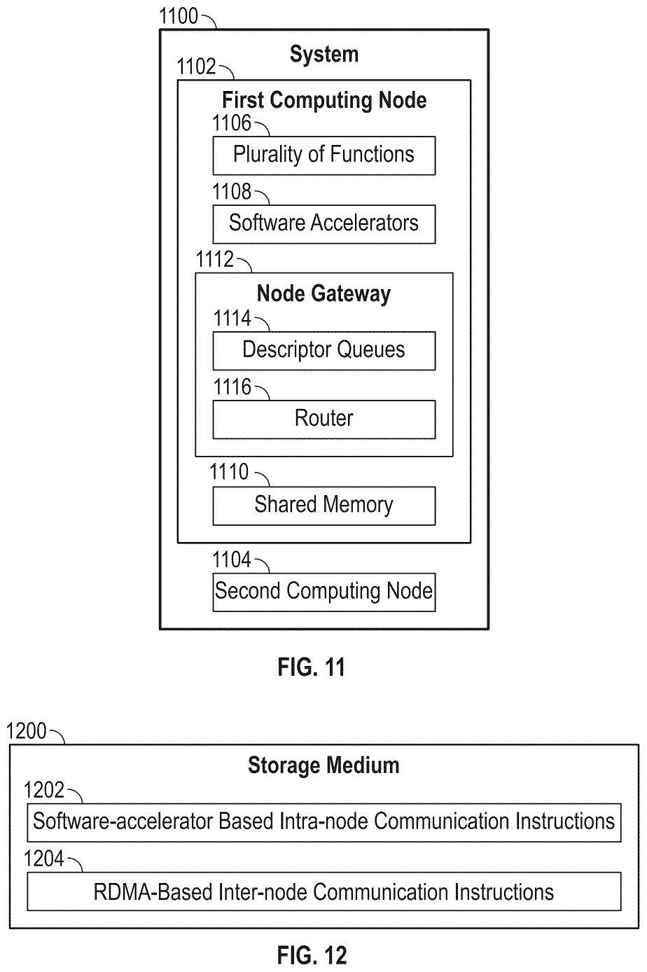

FIG. 11 is a block diagram of a system 1100 according to some examples of the present disclosure. The system 1100 can include any collection of nodes, such as the computing environment 100 of FIG. 1.

The system 1100 has a plurality of computing nodes, which include a first computing node 1102 and a second computing node 1104. The computing nodes can include the worker nodes 802 and 804 of FIG. 8, for example.

The first computing node 1102 includes a plurality of functions 1106 of a chain of functions. The first computing node 1102 further includes software accelerators 1108 associated with respective functions of the plurality of functions 1106. The software accelerators 1108 can include eBPF sidecars or other types of software accelerators. The software accelerators 1108 can perform intra-node data communications between the plurality of functions 1106 using a shared memory 1110 in the first computing node 1102.

The first computing node 1102 further includes a node gateway 1112, such as the node gateway 806 of FIG. 8. The node gateway 1112 includes descriptor queues 1114 to store packet descriptors for data communications. A packet descriptor includes an identifier of a next function of the chain of functions to which data is to be sent, and a pointer to a memory location of the shared memory 1110 where the data is stored. The descriptor queues 1114 can include the RX queues in the gateway RX module 810 of FIG. 8, for example.

The node gateway 1112 further includes router 1116 to perform an inter-node RDMA transfer of data from a first function of the plurality of functions on the first computing node 1102 to a second function of the chain of functions 1106 on the second computing node 1104. The router 1116 can include the gateway core module 812 of FIG. 8, for example.

The software accelerators 1108 and the node gateway 1112 are part of a data plane of the system 1100. The data plane can include an intra-node data plane (e.g., 700 in FIG. 7) and an inter-node data plane (e.g., 800 in FIG. 8).

In some examples, the inter-node RDMA transfer of the data includes a one-sided RDMA write of the data.

In some examples, the router 1116 can select an RDMA queue pair for routing data between the first computing node 1102 and the second computing node 1104.

In some examples, the RDMA queue pair includes a reliable connection queue pair (RC QP) for a point-to-point connection between the node gateway 1112 of the first computing node 1102 and a node gateway of the second computing node 1104.

In some examples, the node gateway 1112 can select the RDMA queue pair from a plurality of available RDMA queue pairs for transfers between the first computing node 1102 and the second computing node 1104. The selecting can be based on which RDMA queue pair of the available RDMA queue pairs has a least workload (e.g., the least quantity of work requests).

In some examples, the node gateway 1112 can select the RDMA queue pair from a plurality of available RDMA queue pairs for transfers between the first computing node 1102 and the second computing node 1104, where the selecting is based on a requirement of the chain of functions.

In some examples, the router 1116 can add a packet descriptor for the inter-node RDMA transfer of data to a send queue of the RDMA queue pair. An example of the send queue is SQ1 in FIG. 8.

In some examples, the router 1116 can access an inter-node routing table (e.g., 872 in FIG. 8) to identify the second computing node 1104 hosting the second function.

In some examples, the software accelerators 1108 include eBPF sidecars, which can include socket message programs to perform the intra-node data communications.

In some examples, a first software accelerator of the software accelerators 1108 can receive a packet descriptor having an identifier of a third function of the plurality of functions 1106 to which data is to be sent. The first software accelerator can access mapping information that correlates identifiers of the plurality of functions 1106 to respective interfaces for the plurality of functions 1106. An example of the mapping information is the socket map 720 of FIG. 7. An example of the interfaces are the sockets 722 and 724 of FIG. 7. The first software accelerator can send the packet descriptor to a target interface for the third function based on an entry of the mapping information that correlates the identifier of the third function to the target interface.

In some examples, the intra-node data communications performed by the software accelerators bypass a kernel network stack (e.g., 714 in FIG. 7) in the first computing node 1102.

In some examples, the inter-node RDMA transfer of data bypasses OS kernel stacks of the first and second computing nodes 1102 and 1104.

In some examples, the second computing node 1104 includes a node memory and an RDMA NIC. The second computing node 1104 includes a further node gateway that can obtain completion information (e.g., a CQE) added to a completion queue responsive to the RDMA NIC writing the data of the inter-node RDMA transfer to the node memory. The further node gateway can determine a memory region containing the data of the inter-node RDMA transfer based on the completion information, and the further node gateway can add a packet descriptor to a descriptor queue of the further node gateway, the packet descriptor including a pointer to the memory region.

In some examples, the second function can use the packet descriptor to retrieve the data of the inter-node RDMA transfer from the node memory.

FIG. 12 is a block diagram of a non-transitory machine-readable or computer-readable storage medium 1200 storing machine-readable instructions that upon execution cause a system including a plurality of computing nodes to perform various tasks.

The machine-readable instructions include software-accelerator based intra-node communication instructions 1202 to perform an intra-node data communication between functions in a first computing node of the plurality of computing nodes using an intra-node data plane including software accelerators associated with the functions. The software accelerators can pass a descriptor for the intra-node data communication, where the descriptor includes a pointer to a memory location of a shared memory in the first computing node.

The machine-readable instructions RDMA-based inter-node communication instructions 1204 to perform an inter-node data communication between a first function on the first computing node and a second function on a second computing node using an inter-node data plane including RDMA NICs of the first and second computing nodes, and RDMA queue pairs in the first and second computing nodes.

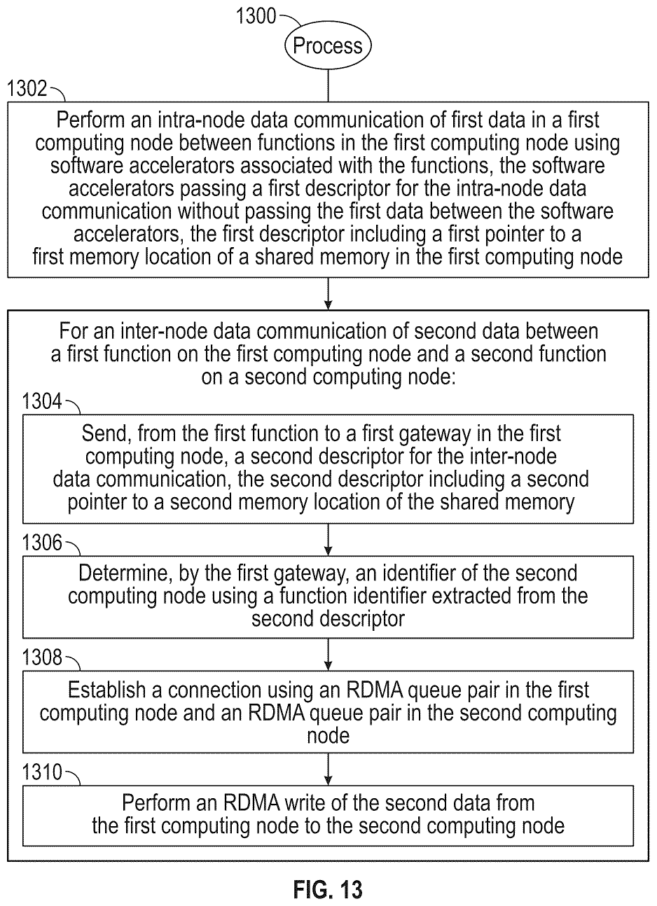

FIG. 13 is a flow diagram of a process 1300 according to some examples of the present disclosure.

The process 1300 includes performing (at 1302) an intra-node data communication of first data in a first computing node between functions in the first computing node using software accelerators associated with the functions, the software accelerators passing a first descriptor for the intra-node data communication without passing the first data between the software accelerators, the first descriptor including a first pointer to a first memory location of a shared memory in the first computing node.

For an inter-node data communication of second data between a first function on the first computing node and a second function on a second computing node, the process 1300 includes sending (at 1304), from the first function to a first gateway in the first computing node, a second descriptor for the inter-node data communication, the second descriptor including a second pointer to a second memory location of the shared memory. The second descriptor can be sent using a socket (e.g., 830 in FIG. 8) of the first gateway, for example.

The process 1300 further includes determining (at 1306), by the first gateway, an identifier of the second computing node using a function identifier extracted from the second descriptor. The determination can be based on the inter-node routing table 872 of FIG. 8, for example.

The process 1300 includes establishing (at 1308) a connection using an RDMA queue pair in the first computing node and an RDMA queue pair in the second computing node. The connection can be an RDMA reliable connection.

The process 1300 includes performing (at 1310) an RDMA write of the second data from the first computing node to the second computing node. The RDMA write can be a one-sided RDMA write.

As used here, a “table” can refer to a data structure having entries that contain respective information.

FIGS. 6, 9, 10, and 13 are flow diagrams of processes with specific orders of tasks. In other examples, the tasks of the processes may be performed in a different order, some tasks may be omitted, and other tasks may be added.

As used here, a “computing node” can include one or more computers. A hardware processor can include a microprocessor, a core of a multi-core microprocessor, a microcontroller, a programmable integrated circuit, a programmable gate array, or another hardware processing circuit. Machine-readable instructions executable on a hardware processor can refer to the instructions executable on a single hardware processor or the instructions executable on multiple hardware processors.

A storage medium (e.g., 500 in FIG. 5 or 1200 in FIG. 12) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A system comprising:
a plurality of computing nodes comprising a first computing node and a second computing node, the first computing node comprising:
a plurality of functions of a chain of functions, and
software accelerators associated with respective functions of the plurality of functions, the software accelerators to perform intra-node data communications between the plurality of functions using a shared memory in the first computing node; and
a gateway comprising:
descriptor queues to store descriptors for data communications, wherein a descriptor of the descriptors comprises an identifier of a next function of the chain of functions to which data is to be sent, and a pointer to a memory location of the shared memory where the data is stored, and
a router to perform an inter-node Remote Direct Memory Access (RDMA) transfer of data from a first function of the plurality of functions on the first computing node to a second function of the chain of functions on the second computing node,
wherein the software accelerators and the gateway are part of a data plane of the system.

2. The system of claim 1, wherein the inter-node RDMA transfer of the data comprises a one-sided RDMA write of the data.

3. The system of claim 1, wherein the router is to select an RDMA queue pair for routing data between the first computing node and the second computing node.

4. The system of claim 3, wherein the RDMA queue pair comprises a reliable connection queue pair (RC QP) for a point-to-point connection between the gateway of the first computing node and a gateway of the second computing node.

5. The system of claim 3, wherein the gateway is to select the RDMA queue pair from a plurality of available RDMA queue pairs for transfers between the first computing node and the second computing node, wherein the selecting is based on which RDMA queue pair of the available RDMA queue pairs has a least workload.

6. The system of claim 3, wherein the gateway is to select the RDMA queue pair from a plurality of available RDMA queue pairs for transfers between the first computing node and the second computing node, wherein the selecting is based on a requirement of the chain of functions.

7. The system of claim 3, wherein the router is to add a descriptor for the inter-node RDMA transfer of data to a send queue of the RDMA queue pair.

8. The system of claim 1, wherein the router is to access an inter-node routing table to identify the second computing node hosting the second function.

9. The system of claim 1, wherein the software accelerators comprise extended Berkeley Packet Filter (eBPF) sidecars.

10. The system of claim 9, wherein the eBPF sidecars comprise socket message programs to perform the intra-node data communications.

11. The system of claim 1, wherein a first software accelerator of the software accelerators is to:
receive a descriptor comprising an identifier of a third function of the plurality of functions to which data is to be sent;
access mapping information that correlates identifiers of the plurality of functions to respective interfaces for the plurality of functions; and
send the descriptor to a target interface for the third function based on an entry of the mapping information that correlates the identifier of the third function to the target interface.

12. The system of claim 11, wherein the mapping information correlates the identifiers of the plurality of functions to respective socket interfaces for the plurality of functions.

13. The system of claim 1, wherein the intra-node data communications performed by the software accelerators bypass an operating system (OS) kernel stack in the first computing node.

14. The system of claim 1, wherein the inter-node RDMA transfer of data bypasses OS kernel stacks of the first and second computing nodes.

15. The system of claim 1, wherein the second computing node comprises:
a node memory;
an RDMA network interface controller (NIC); and
a further gateway to:
obtain completion information added to a completion queue responsive to the RDMA network interface controller writing the data of the inter-node RDMA transfer to the node memory;
determine a memory region containing the data of the inter-node RDMA transfer based on the completion information; and
add a descriptor to a descriptor queue of the further gateway, the descriptor including a pointer to the memory region.

16. The system of claim 15, wherein the second function is to use the descriptor to retrieve the data of the inter-node RDMA transfer from the node memory.

17. A non-transitory machine-readable storage medium comprising instructions that upon execution cause a system comprising a plurality of computing nodes to:
perform an intra-node data communication between functions in a first computing node of the plurality of computing nodes using an intra-node data plane comprising software accelerators associated with the functions, the software accelerators to pass a descriptor for the intra-node data communication, the descriptor comprising a pointer to a memory location of a shared memory in the first computing node; and
perform an inter-node data communication between a first function on the first computing node and a second function on a second computing node using an inter-node data plane comprising Remote Direct Memory Access (RDMA) network interface controllers (NICs) of the first and second computing nodes, and RDMA queue pairs in the first and second computing nodes.

18. The non-transitory machine-readable storage medium of claim 17, wherein the instructions upon execution cause the system to:
access, at the first computing node, an inter-node routing table that correlates function identifiers to respective computing nodes; and
identify, using the inter-node routing table, the second computing node based on a function identifier of the second function.

19. A method comprising:
performing an intra-node data communication of first data in a first computing node between functions in the first computing node using software accelerators associated with the functions, the software accelerators passing a first descriptor for the intra-node data communication without passing the first data between the software accelerators, the first descriptor comprising a first pointer to a first memory location of a shared memory in the first computing node;
for an inter-node data communication of second data between a first function on the first computing node and a second function on a second computing node:
sending, from the first function to a first gateway in the first computing node, a second descriptor for the inter-node data communication, the second descriptor comprising a second pointer to a second memory location of the shared memory;
determining, by the first gateway, an identifier of the second computing node using a function identifier extracted from the second descriptor;
establishing a connection using a Remote Direct Memory Access (RDMA) queue pair in the first computing node and an RDMA queue pair in the second computing node; and
performing an RDMA write of the second data from the first computing node to the second computing node.

20. The method of claim 19, further comprising:
determining, by a second gateway in the second computing node, a memory region in a shared memory of the second computing node where the second data is stored, the determining being based on an identifier of the RDMA queue pair in the second computing node and an identifier of the RDMA queue pair in the first computing node.
